(19) United States
(12) Patent Application Publication
(10) Pub. No.: US 2006/0007147 A1
(43) Pub. Date: Jan. 12, 2006

(54) Wireless mouse with multiple charging modes

(76) Inventor: Cruise Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/883,663

(22) Filed: Jul. 6, 2004

(51) Int. Cl. G09G 5/08

(52) U.S. Cl. 345/163

(57) ABSTRACT

A wireless mouse with multiple charging modes is provided. In the mouse body, through using a transforming inductance mounted therein and an adapter with multiple sockets, a common mobile charger can be easily used to charging the wireless mouse. Alternatively, through being connected to a receiver via a connecting wiring, the mouse body and the receiver may be connected to one identical transportation port and the mouse body can simultaneously charged under operating. Furthermore, the mouse body may be positioned in a resting place as unused for recharging the battery thereinside.

### FIELD OF THE INVENTION

The present invention is related to a wireless mouse with multiple charging modes and more particular to a wireless mouse body which can be easily charged by a common mobile charger through using a transforming inductance mounted therein and an adapter with multiple sockets, or through being connected to a receiver via a connecting wiring, the mouse body and the receiver may be connected to one identical transportation port and the mouse body can simultaneously be charged. Furthermore, the mouse body may be positioned in a resting place for recharging the battery thereinside through the power provided via the resting place.

### DESCRIPTION OF THE PRIOR ART

The mouse has already been a standard accessory for most computers and operating systems, the wireless equipments is increasingly popularized and the conventional connection, such as RS232 signal wiring, between the mouse and the computer is gradually replaced by transmission interface, such as USB. However, the known wireless mouse still has some defects should be improved.

1. The frequent replacement of battery: Because the wireless mouse does not own a signal wiring and the power for operating should be supplied by itself, once the inner power has been consumed, the battery must be replaced immediately. The more the frequency used, the more the frequency replaced.

2. Inconvenient charging line for the wireless mouse: If the wireless mouse owns a rechargeable carrier therein, an additional charging line is still needed for the charging each time. But, if it should prepare a charging line for a wireless using all the time, what is the different between the wireless mouse and the “wired” mouse.

3. The occupancy of USB port: Usually, the notebook only has USB ports up to 2 to 3 ones, and thus, when the wireless mouse is normally under using, the receiver has already occupied one USB port. Then, when recharging the wireless mouse, another USB port must be occupied therefor.

Thus, it can be seen, the conventional wireless mouse still has some defects and is not a good design. Because of the technical defects of described above, the applicant keeps on carving unflaggingly to develop a wireless mouse with multiple charging modes through wholehearted experience and research.

### SUMMARY OF THE INVENTION

One object of the present invention is to provide a wireless mouse with multiple charging modes and having a universal socket, namely, a wireless mouse with multiple charging modes which can be recharged through a common mobile charger.

Another object of the present invention is to provide a wireless mouse having a receiver employing a USB interface, wherein the receiver has a socket for plugging a connecting wiring of the mouse body so that the wireless mouse can operate normally and can be charged through the socket on the receiver simultaneously without additionally occupying another USB port for charging.

Another further object of the present invention is to provide a wireless mouse having a charging circuit comprising a transforming inductance and a constant voltage regulator mounted therein so that the mouse may be connected to the transformers with different standards for power storage, and the wireless mouse also can prevent an error assembling through the structural design.

For achieving the purposes described above, the wireless mouse with multiple charging modes according to the present invention includes a receiver, a control circuit and a wireless mouse body for achieving multiple charging manners. The mouse body has a charging socket thereinside for positioning common disposable battery or rechargeable battery so as to provide the electricity to the control circuit, wherein the charging socket can prevent an error assembling of the battery through a structural design. The control circuit, in addition to the conventional encoding/decoding circuit for transforming the motions of the mouse body into electrical signals, also comprises a protecting switch for protecting the inner circuit through turning off the circuit loop when the voltage or the current is overloaded or the connection of the positive and negative electrodes is incorrect. Furthermore, the control circuit also has a constant voltage regulator and a transforming inductance for avoiding the defect that the common charging mouse should be matched to a charger with a particular standard of its own. Therefore, the standards of the charger of the wireless mouse with multiple charging modes according to the present invention that can be used can be further expanded to the common mobile charger. A plugging hole, which can be a universal socket, is positioned at the left side of the mouse so that even a charger for a common mobile (for example, NOKIA 6150) can be used for charging the mouse of the present invention. Alternatively, through being connected to a receiver via a connecting wiring, the mouse body can be simultaneously charged as operating. And, the mouse body may be positioned in a resting place as unused for simultaneously recharging the battery thereinside through the power provided via the resting place.

### BRIEF DESCRIPTION OF THE DRAWINGS

The drawings disclose an illustrative embodiment of the present invention which serves to exemplify the various advantages and objects hereof, and are as follows:

FIG. 1A is a schematic view showing an inner circuit of a mouse in the prior art;

FIG. 1B is a schematic view showing an inner circuit of a mouse according to the present invention;

### DETAILED DESCRIPTION OF THE PREFERRED EMBODIMENT

For further understanding of the structure, usage and features of the present invention, the following embodiments are described for more detailed explanation with reference of the drawings:

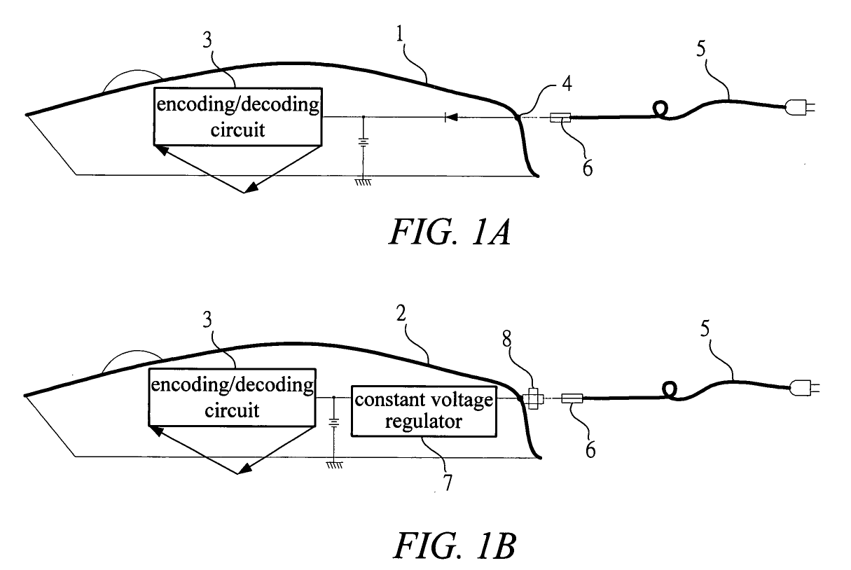

Please refer to FIG. 1A which is a schematic view showing the inner circuit of the conventional mouse. As shown in FIG. 1A, the conventional wireless optical mouse 1 always employs an encoding/decoding circuit 3 for transforming the alternation of the optical signal owing to the position change of the mouse caused by user operation into electrical signals which are distinguishable by the computer. Furthermore, the conventional wireless optical mouse 1 may be connected to an external electricity through a charger 5 for being the power source. However, because the socket 4 and the plug 6 for the charger 5 are reciprocally male and female ones, each kind of mouse will need an exclusive charger 5 and different kinds of chargers 5 cannot be mutually exchanged. FIG. 1B is schematic view showing an inner circuit of a mouse according to the present invention. The inner circuit of the wireless mouse with multiple charging modes 2 according to the present invention, in addition to the conventional encoding/decoding circuit 3 for transforming the motions of the mouse into electrical signals for computer distinguishing, further comprises a constant voltage regulator 7 and an adapter 8. Through the adapter 8 according to the present invention, various designs of the plug 6 of the charger 5 can be conformed thereto. Furthermore, because chargers 5 of different brands may have different output voltages, the constant voltage regulator 7 of the present invention may transform various input voltages (approximately 4V to 6V) into a conformable input voltage (approximately 5V). Therefore, the standards of the charger of the wireless mouse with multiple charging modes according to the present invention that can be used even can be expanded to the common mobile charger.

Between the upper case and the lower case of the mouse, the inner circuit and inner power supply are positioned. A charging socket is provided for positioning a common disposable battery or a rechargeable battery so as to provide the power to the inner circuit of the mouse. Furthermore, the present invention also can prevent an assembling error caused by positioning the battery in a wrong direction (oppositely connecting the positive and negative electrodes) through a structural design. In addition, the present invention also has a protecting switch, and thus, when the external voltage is different from a predetermined value, the protecting switch will not be conducted for turning off the circuit so as to protect the inner circuit. A plugging hole is positioned at the left side of the mouse for externally connecting to an adapter 8 so that even a charger for a common mobile (for example, NOKIA 6150) can be used for charging the mouse of the present invention.

When the wireless mouse of the present invention is unused, it can be positioned in a resting place, which has a metal connecting point, so that battery inside the wireless mouse also can be charged by the DC voltage from the computer through being connected to the metal connecting point via the adapter with multiple sockets.

When the wireless mouse according to the present invention is under used, a connecting wiring may be further used to connect the mouse body and the receiving end for simultaneous charging as operating.

The wireless mouse with multiple charging modes according to the present invention, when being compared with the other prior arts, further includes the advantages as follows:

1. Through a universal socket, the present invention can be combined with a common mobile charger so as to avoid the inconvenience that each wireless equipment may be matched to only one kind of charger for more efficient resource usage.

2. As the wireless mouse of the present invention is unused, it can be positioned in a resting place for not only avoiding an inconvenient searching as starting operation but also charging the mouse simultaneously for preparation.

3. The present invention provides multiple charging modes so that the wireless mouse may be charged through at least two manners under any kind of operation condition. Thus, it owns the convenience.

4. The present invention and its relative components are all simple designed and have at least two operating ways so that the resource may be completely used.

Many changes and modifications in the above described embodiment of the invention can, of course, be carried out without departing from the scope thereof.

Accordingly, to promote the progress in science and the useful arts, the invention is disclosed and is intended to be limited only by the scope of the appended claims.

What is claimed is:

1. A wireless mouse with multiple charging modes comprising a mouse body and a receiver, wherein said mouse body has a signal circuit and a battery socket mounted thereinside for forming a signal instruction of said mouse body, and said receiver has a receiving circuit connected to a host of a computer for receiving a wireless signal from said mouse body so as to achieve a signal transportation between said mouse body and said host, characterized in that:
said mouse body further comprises a transforming inductance and a constant voltage circuit mounted thereinside and an adapter with multiple sockets on a case thereof so that a mobile charger is allowed to connect to said sockets of said adapter for providing an electricity to said wireless mouse body and also charging said wireless mouse body.

2. A wireless mouse according to claim 1, wherein said wireless mouse body is allowed to connect to said receiver through a connecting wiring so that said mouse body and said receiver are connected to one identical transportation port of said computer and said mouse body is simultaneously charged under using.

3. A wireless mouse according to claim 1, wherein said mobile charger has an output voltage ranged from 4V to 6V.

4. A wireless mouse according to claim 1, wherein said adapter with multiple sockets is a socket in conjugation with plural adapters.
